(19) United States
(12) Patent Application Publication
(10) Pub. No.: US 2011/0224989 A1
(43) Pub. Date: Sep. 15, 2011

(54) Methods and Systems for Word Tone Implementation

(76) Inventor: Cornelius Johnson, Petersburg, VA (US)

(21) Appl. No.: 13/046,691

(22) Filed: Mar. 11, 2011

Related U.S. Application Data
(60) Provisional application No. 61/339,967, filed on Mar. 11, 2010.

(51) Int. Cl. G10L 21/00

(52) U.S. Cl. 704/272; 704/E21.001

(57) ABSTRACT

Word Tone uses one or more recordings of recognizable scriptures and sets it to an appropriate custom beat or rhythm which enhances the enjoyment of the recorded verse. Further exemplary embodiments enable the user to set up a plurality of profiles for one or more callers such that the electronic device selectively presenting one of a plurality of word tones for an associated incoming call. For example, missionaries who are not allowed to carry Bibles or other documents in foreign countries, may set up the incoming calls to play rings tones sequentially organized by book of the bible and scripture (e.g., John 3:16, then John 3:17, and so on) or selectively by sermon from different books and scriptures on a themed topic associated by the user. Moreover, the scope of the present invention is not to be limited to specific verse or scripture, but is instead intended to encompass any spoken religious verse(s), inspirational quotes, messages, sermons, or spoken sentiments recorded and set to a beat, as embodied in the present invention.

### COPENDING APPLICATION

This application claims priority benefit of U.S. Provisional Application Ser. No. 61/339,967 entitled “METHODS AND SYSTEMS FOR WORD TONE IMPLEMENTATION”, filed on Mar. 11, 2010, having the same inventor of the instant patent application and of which is incorporated herein by reference as if set forth in full below.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

### Field

This invention relates generally to the field of communications. More particularly, this invention relates to systems, methods, and apparatuses that provide downloadable or real-time audio delivery of scriptures set to a beat for incoming communications signals to a computer or another communications device.

Currently, many electronic devices such as cell phones, clocks, computers, timers, watches, etc. allow a user to customize ringtones, notification tones, and function sounds by downloading online recordings. While many websites provide music and speech recordings to be downloaded for a fee, there are no custom tones that include a spoken religious scripture set to a beat.

There exists a need for a custom audio tone that combines a spoken religious verse with an accompanying beat or meter. The Word Tone product provides recordings of spoken Bible verses set to an appealing beat that can be purchased and downloaded to any device that contains a digital signal processor, which can then store the recording and set it as a ringtone or notification tone on the device.

### SUMMARY

The aforementioned gap in the downloadable audio tone market is remedied by the Word Tone product, that provides a recognizable scripture set to a memorable beat. The Word Tone tracks may be purchased from the inventor's website for an affordable lee, for example $0.99 per track, and downloaded onto any electronic device with the capability to store and play digital audio tones and notification sounds. For example, Word Tone tracks may be used as notification alerts on computers, personal electronic devices, oven and kitchen timers, pedometers, heart monitors, and other electronic sports devices, as alarms for alarm clocks, used as cell phone ringtones, and/or simply recorded on MP3 devices or compact disks for recreational listening.

Other uses, incarnations, and/or products in accord with the embodiments of the Word Tone product will be or become apparent to one with the relevant knowledge upon examination of the figures and further description subsequently provided. For example, one of ordinary skill in the art would recognize that ring backs or audio recordings could be played to an incoming caller from a communications switch or other network device. It is intended that all such additional uses, incarnations, methods, and products, including other religious or inspirational verses set to a beat, be included within this description, be within the scope of the present invention, and be safeguarded by the accompanying claims.

### BRIEF DESCRIPTION OF THE DRAWINGS

The possible embodiments, objects, uses, advantages, and novel features are more clearly understood by reference to the following description taken in conjunction with the with the accompanying figures herein:

FIG. 1 illustrates a system overview of the invention according to an exemplary embodiment of the present invention;

FIG. 2 illustrates a block diagram of the possible components and the acquisition process for the Word Tone product according to an exemplary embodiment of the present invention;

FIG. 3 is a schematic showing the Word Tone Notification Module operating within a telecommunications system according to an embodiment of this invention;

FIG. 4 is a detailed schematic of the telecommunications system shown in FIG. 3;

FIG. 5 is a schematic illustrating the selection of Word Tone audio tones according to an embodiment of this invention;

FIG. 6 is a schematic showing that the customer may customize the audio tones according to an embodiment of this invention;

FIGS. 7 and 8 are schematics illustrating the processing of an incoming call to a called telephone number according to an embodiment of this invention;

FIG. 9 is a flowchart of an overview of a communications method for audio delivery of a Word Tone (scripture set to beat or rhythm) to a PC or other IP communications device according to an embodiment of this invention;

FIG. 10 is a flowchart showing an alternative communications method for audio delivery of a Word Tone (scripture set to beat or rhythm) according to another embodiment of this invention;

FIG. 11 is a schematic showing the Word Tone Notification Module according to an alternate embodiment of this invention; and

FIG. 12 is a block diagram of an exemplary apparatus embodying this invention.

### DESCRIPTION

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function regardless of structure).

Thus, for example, it will be appreciated by those skilled in the art that the block diagrams, schematics, and the like represent conceptual views of illustrative circuitry embodying this invention. Similarly, it will be appreciated that any flow charts, flow diagrams, and the like represent various processes which may be substantially represented in computer readable medium and so executed by a computer or processor, whether or not such computer or processor is explicitly shown.

The functions of the various elements shown in the figures, including functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those skilled in the art further understand that the exemplary hardware, software, processes, methods, and/or operating systems described herein are for illustrative purposes and thus, are not intended to be limited to any particular named manufacturer.

The words “present invention” are used herein to describe all of the attributes and possible incarnations of the invention, as well as any equivalent systems or forms of the invention. For example, the “present invention” would also include alternative religious verses, quotations, or other spoken recordings set to an original beat or meter that may be downloaded and used on any electronic device as a ring tone, notification tone, or function sound. The “embodiments” of the invention discussed forthwith may include synthetic materials, natural materials, and/or combinations thereof, and may take on many different forms, sounds, and content.

The exemplary embodiments of the present invention will now be described in greater detail, with some reference to the accompanying figures. This invention may, however, be construed in many different forms and should not be considered limited to the specific embodiments described herein. The description of these embodiments are provided in order to give a thorough and complete disclosure and are intended to convey the full scope of the invention to those with relevant knowledge of the field. All statements within this document that describe the embodiments of the present invention are intended to encompass both structural and functional equivalents thereof. Such equivalents are intended to include both current equivalents and any equivalents that may be developed in the future, regardless of structure, that provide the same function.

The Word Tone invention involves at least one electronic device that has a digital signal processor which may store and make use of audio files, as well as an electronic device that has the capability to access and download material from the World Wide Web (WWW). These two functions may or may not be contained within the same electronic device. These devices may include, but are not limited to cell phones, laptops, desktop computers, iPads. Devices that may download the audio tracks from the web-accessible device include but are not limited to clocks, personal electronic planners, iPods, digital picture frames, digital watches, electronic oven and kitchen timers, sports devices such as pedometers or heart rate monitors, cell phones, laptops, desktop computers, iPads, electronic book readers (e.g. Kindle), CDs, USB drives, and any other electronic devices with digital signal processing ability.

This system is meant to be accessed using wireless and/or non-wireless devices. Multiple websites, for example the iTunes website, currently provide downloadable ring tones and custom notification tones in the form of song excerpts, voice recordings, etc. The user selects and purchases at least one custom tone (and more typically a plurality of tones) and downloads the tone(s) to their electronic device through various graphical user interfaces (GUIs). The electronic device is configured to store the tone(s) for selective playback, as ringtone, or some variation of a notification or function tone (i.e. a sound that notifies the user when a function has been started or completed, for example if a new e-mail is received).

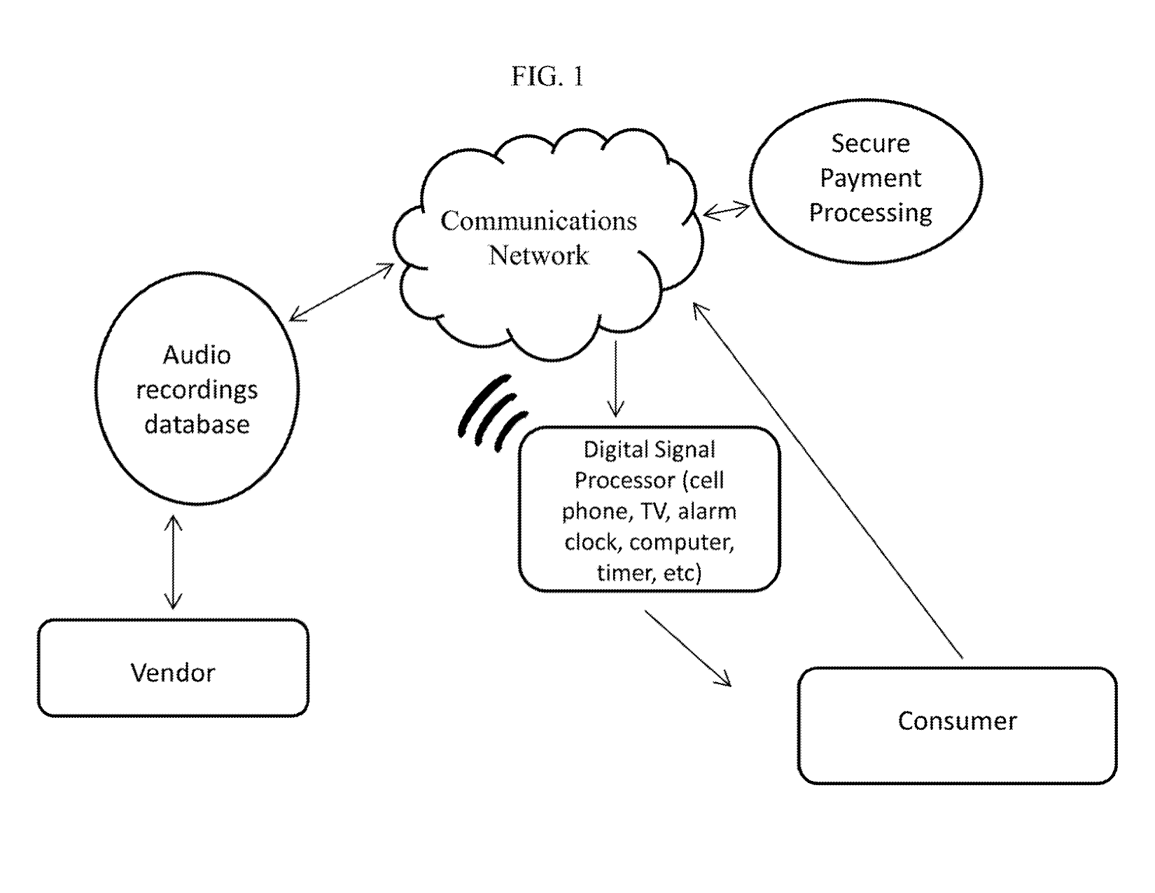

The present invention is to be accessed and employed using the aforementioned methods already established in the downloading of music and voice recording tones, and seen in the system of FIG. 1. Word Tone uses one or more recordings of recognizable Bible scriptures and sets it to an appropriate custom beat or rhythm which enhances the enjoyment of the recorded verse. Further exemplary embodiments enable the user to set up a plurality of profiles for one or more callers such that the electronic device selectively presenting one of a plurality of word tones for an associated incoming call. For example, missionaries who are not allowed to carry Bibles or other documents in foreign countries, may set up the incoming calls to play rings tones sequentially organized by book of the bible and scripture (e.g., John 3:16, then John 3:17, and so on) or selectively by sermon from different books and scriptures on a themed topic associated by the user. Moreover, the scope of the present invention is not to be limited to specific verse or scripture, but is instead intended to encompass any spoken religious verse(s), inspirational quotes, messages, sermons, or spoken sentiments recorded and set to a beat, as embodied in the present invention. Word Tone products may be employed in a variety of different electronic advices as a downloadable tone for the purposes of ringtones, notification tones, functional tones, or recreational listening.

Some of the exemplary embodiments disclose a Word Tone configured to provide recordings of spoken King James Bible scripture set to a custom beat which enhances the enjoyment of listening to the scripture. Word Tone recordings exist for religious, edification, and recreational purposes, to be used by the buyer. The Word Tone website will provide a number of different spoken scriptures and verses set to custom beats in an audio database, to be purchased individually or collectively by the buyer at an affordable price, such as, for example, $0.99 per scripture.

The Word Tone product of the present invention encompasses any spoken saying, quotation, or verse set to an original beat or meter that is able to be downloaded, stored, and/or used on any electronic device, current or future, capable of storing and using audio files.

The Word Tone website will ensure that payment is achieved through a secure payment processing system, such as PayPal. Once a Word Tone product is purchased, the scripture may be shared with related users, for example family members within the home. However, the Word Tone product is not to be distributed to non-related users. Furthermore, this patent is intended to safeguard Word Tone products against imitation and distribution by all other individuals and entities.

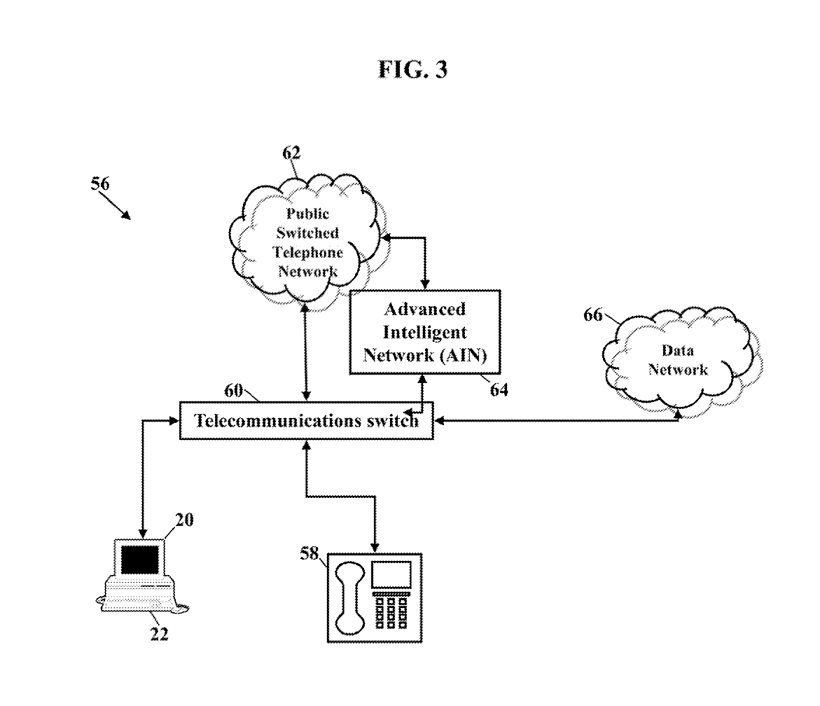

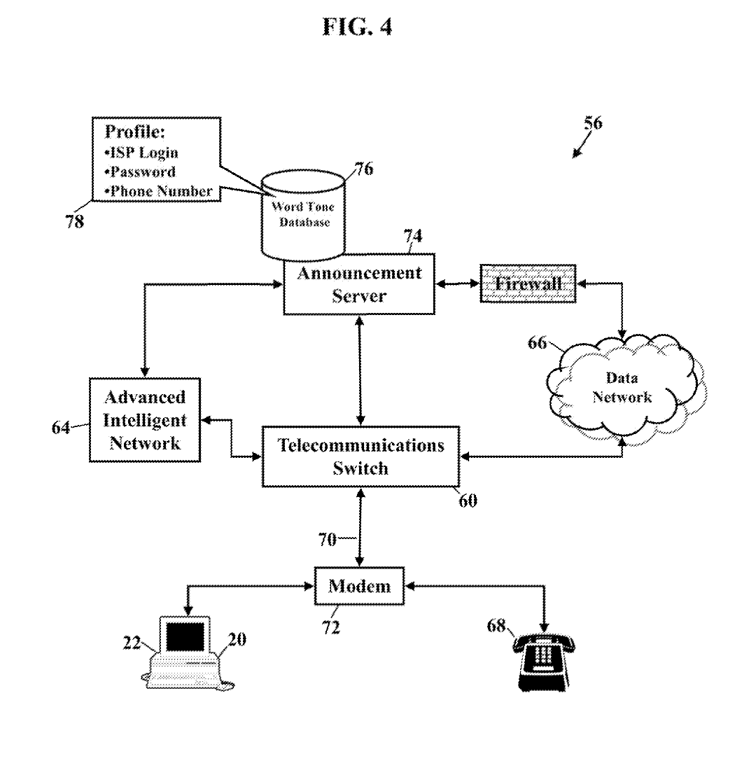

FIGS. 3 and 4 depict operating environments for further exemplary embodiments of this invention. This embodiment of Word Tone includes a computer program that allows a customer to customize audio ringtones or notification alerts presented by a PC or IP communications device servicing a called telephone number (or to a Service Node address). As used herein, the term “IP communications device” includes a wireless phone, a cellular phone, a satellite phone, a computer, a modem, an audio pager, a personal digital assistant, a digital signal processor, a global positioning system transceiver, an interactive television, and other IP addressable communications devices capable of delivering audio communications. Word Tone allows the customer to select a desired scripture set to a beat based upon a variety of identifying information fields that are typically accessible in a communications network 62. For example, the identification fields may include information associated with at least one of the following: an originating telephone number, a name associated with the originating telephone number, a time of day, a date identifier (e.g., day of week or calendar date), a geographic identifier, and/or similar information associated with the ICLID signal. The selected announcement typically includes a recording of a spoken scripture set to an original beat or meter that may accompany an incoming call (i.e., an incoming communications signal), text message, of phone function. When an incoming call is transmitted to the called telephone number, the selected Word Tone is audibly delivered to computer or other IP communications device.

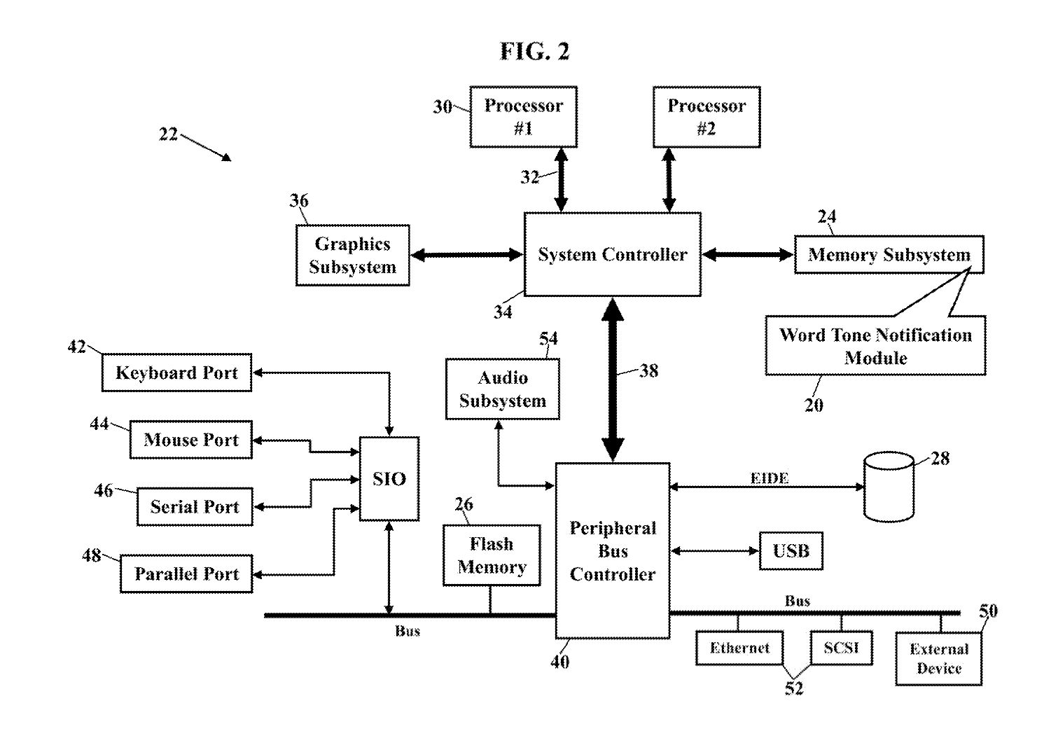

FIG. 2 is a block diagram showing the Word Tone Notification Module residing in a computer system 22 and/or smart phone system. The Word Tone Notification Module operates within a system memory device. The Word Tone Notification Module, for example, is shown residing in a memory subsystem 24. The Word Tone Notification Module, however, could also reside in flash memory 26 or peripheral storage device 28. The computer system also has one or more central processors 30 executing an operating system. The operating system, as is well known, has a set of instructions that control the internal functions of the computer system. A system bus 32 communicates signals, such as data signals, control signals, and address signals, between the central processor and a system controller 34 (typically called a “Northbridge”). The system controller provides a bridging function between the one or more central processors, a graphics subsystem 36, the memory subsystem, and a PCI (Peripheral Controller Interface) bus 38. The PCI bus is controlled by a Peripheral Bus Controller 40. The Peripheral Bus Controller (typically called a “Southbridge”) is an integrated circuit that serves as an input/output hub for various peripheral ports. These peripheral ports could include, for example, a keyboard port 42, a mouse port 44, a serial port 46 and/or a parallel port 48 for a video display unit, one or more external device ports 50, and networking ports 52 (such as SCSI or Ethernet). The Peripheral Bus Controller could also include an audio subsystem 54.

The processor 30 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com).

The preferred operating system is WINDOWS® (WINDOWS® is a registered trademark of Microsoft Corporation, One Microsoft Way, Redmond Wash. 98052-6399, 425.882.8080, www.Microsoft.com). Other operating systems, however, are also suitable. Such other operating systems would include the UNIX® operating system (UNIX® is a registered trademark of the Open Source Group, www.opensource.org), the UNIX-based Linux operating system, WINDOWS NT®, and Mac® OS (Mac® is a registered trademark of Apple Computer, Inc., 1 Infinite Loop, Cupertino, Calif. 95014, 408.996.1010, www.apple.com).

The system memory device (shown as memory subsystem 24, flash memory 26, or peripheral storage device 28) may also contain an application program. The application program cooperates with the operating system and with a video display unit (via, the serial port 46 and/or the parallel port 48) to provide a Graphical Customer Interface (GUI). The Graphical Customer Interface typically includes a combination of signals communicated along the keyboard port 42 and the mouse port 44. The Graphical Customer Interface provides a convenient visual and/or audible interface with the customer or user of the computer system 22. As is apparent to those skilled in the art, the selection and arrangement of the audio a Word Tone (scripture set to beat or rhythm) may be programmed over a variety of alternate mediums, such as, for example, a voice-activated menu prompt, an interactive session with an telecommunications network administrator, and the like.

FIG. 3 is a schematic showing the Word Tone Notification Module operating within the telecommunications system 56. The telecommunications system may include wired, optical, and/or wireless elements. This telecommunications system further represents an operating environment for the Word Tone Notification Module. The Word Tone Notification Module operates within the memory (such as memory subsystem 24, flash memory 26, or peripheral storage device 28 shown in FIG. 1) of the computer system 22. The Word Tone Notification Module could alternatively operate with the memory of an Internet Protocol (IP) phone, other IP communications devices, and IP addressable wireless devices capable of delivering audio communications (e.g., MP3 player). The telecommunications system includes a telecommunications switch 60 of the PSTN 62. Alternatively, the telecommunications system may include private network elements, such as private branch exchanges (PBXs), and/or other elements. The telecommunications switch includes Advanced Intelligent Network (AIN) componentry 64 controlling many features of the telecommunications switch. The telecommunications switch could also include a packet-based “soft switch” that uses software control to provide voice, data, and video services by dynamically changing its connection data rates and protocols types. If the telecommunications system 56 should include a softswitch, the AIN componentry is replaced by an application server that interfaces with the softswitch via a packet protocol, such as Session Initiation Protocol (SIP). The computer system may also interface with a data network 66 via a connection to the telecommunications switch. The signaling between the telecommunications switch, the PSTN including the AIN, and the data network, however, are well understood in the art and will not be further described. Those of ordinary skill in the art will be able to apply the principles of the invention to their own network configurations which may differ substantially from the telecommunications system as shown in FIG. 3.

FIG. 4 is a more detailed schematic of the telecommunications system 56 shown in FIG. 3. FIG. 4 illustrates how the Word Tone Notification Module may be used to establish an audio caller identification tone to the computer system 22 or the called telephone number. The computer system and the called telephone 68 communicate with the telecommunications switch 60 via a connection 70 to a cable/DSL modem 72. Alternatively, the telecommunications switch may establish the connection via a dial-up modem (not shown). The computer system thus receives packetized data messages from the data network 66 via the connection to the telecommunications switch, while the telephone receives the incoming telephone call via the connection to the telecommunications switch. The Word Tone Notification Module may, therefore, be downloaded via the data network from an Word Tone server 74. The Word Tone Notification Module is stored, and operates, within the memory of the computer system.

The Word Tone Notification Module is used to establish an audio caller identification tone and/or notification alert profile for the computer system 22. The tone server 74 stores a database 76 of audio tone information profiles. The customer interacts with the Word Tone Notification Module and with the computer system to access the Word Tone server, to login to the Word Tone server, and to establish a profile 78 in the database of audio tone information profiles. As FIG. 4 shows, the profile could contain, for example, the customer's Internet Service Provider (ISP) login information, a password, and a telephone number servicing the computer system.

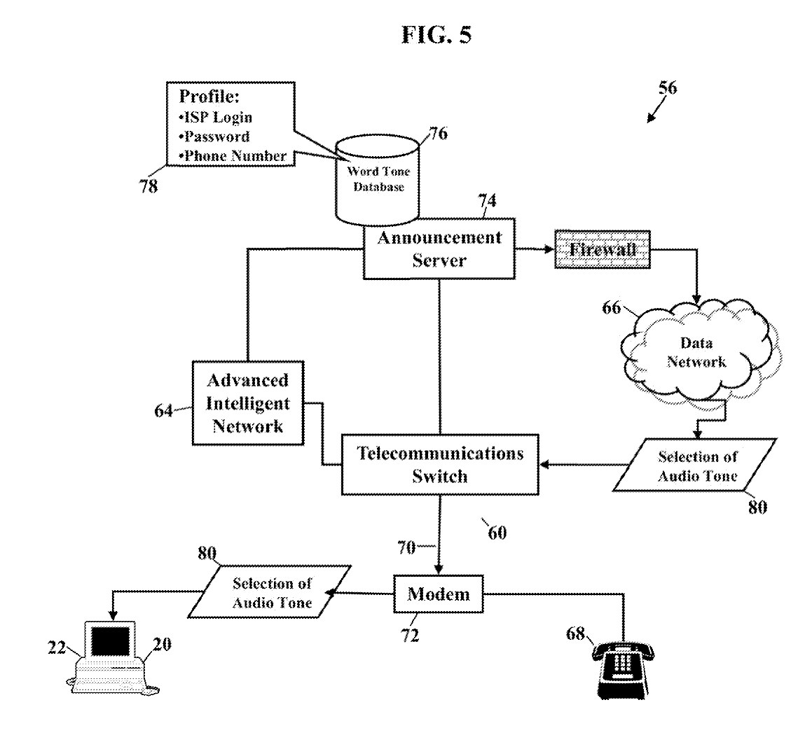

FIG. 5 is a schematic illustrating the selection of announcements. After the customer establishes the profile 78 in the database 76 of audio tone profiles, the customer interacts with the Word Tone Notification Module to download a selection 80 of Word Tone audio tones. The selection is communicated from the Word Tone server 74, over the data network 66, through the telecommunications switch 60, and via the connection 70 to the computer system 22. The selection could include a field and/or file associated with at least one of the following an originating telephone number, a name associated with the originating telephone number, a time of day, a date identifier (e.g., day of week or calendar date), a geographic identifier, and/or similar information associated with the ICLID signal. The selection of tones and/or files are then stored within the memory (such as memory subsystem 24, flash memory 26, or peripheral storage device 28 shown in FIG. 1) of the computer system. The selection preferably resides in the same directory structure as the Word Tone Notification Module.

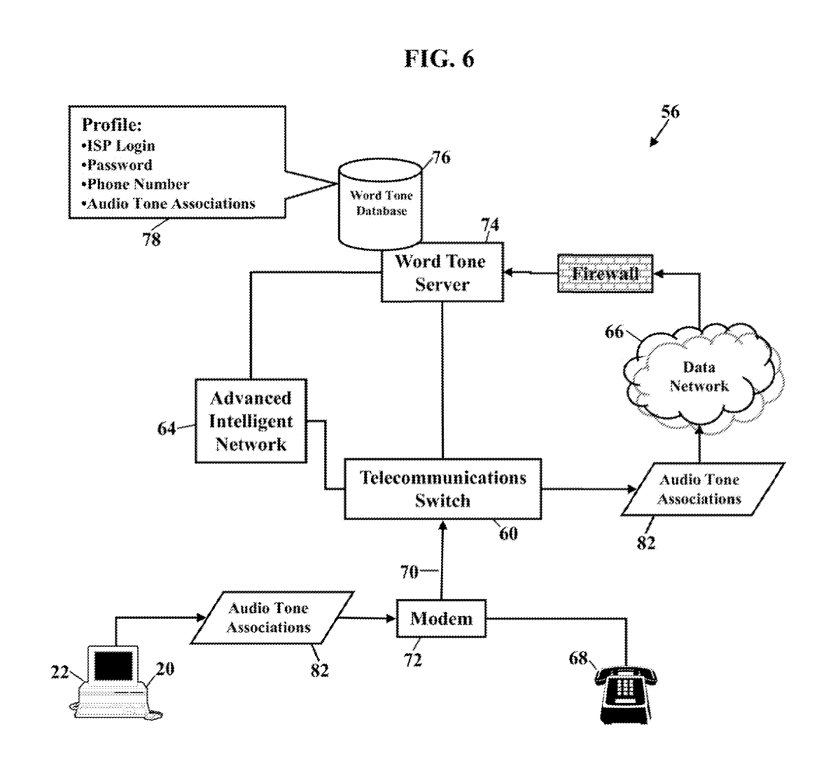

FIG. 6 is a schematic showing that the customer may customize the announcements. After the customer has downloaded his/her selection of tones and/or files (shown as reference numeral 80 in FIG. 5), the customer interacts with the Word Tone Notification Module to customize his/her announcements. The Word Tone Notification Module, in other words, allows the customer to select which tone is played and under what conditions that tone is played. The Word Tone Notification Module allows the customer to select a variety of factors, such as, for example, different tones based upon the time of day and/or the day of week. The customer, for example, could select a first distinctive tone for calls received between 8:00 AM-12:00 PM EST each morning, while a second distinctive tone is selected for calls received only on Friday afternoons. The Word Tone Notification Module also allows the customer to associate a tone with a particular originating telephone number (i.e., an incoming called from a calling party). The customer, for example, could select a third distinctive tone when the calling party is a work phone number, a fourth distinctive tone when the calling party is a spouse's cell phone number, and a fifth distinctive tone when the calling party is a grandparent's phone number. The Word Tone Notification Module further allows the customer to select unique audio tones and/or call handling options for unlisted telephone numbers, for CallerID-Blocked telephone numbers, for “private” telephone numbers, for “out-of-area” telephone numbers, and other incoming calls that are not associated (or have a limited association) with a Word Tone (scripture set to beat or rhythm). Once the customer has customized the tones, the Word Tone Notification Module communicates tone associations 82 to the Word Tone server 74. The announcement associations represent the customer's customized announcement profiles. The tone associations are communicated via the connection 70, through the telecommunications switch 60, over the data network 66, and to the Word Tone server. The profile 78 is then updated with the customer's tone associations.

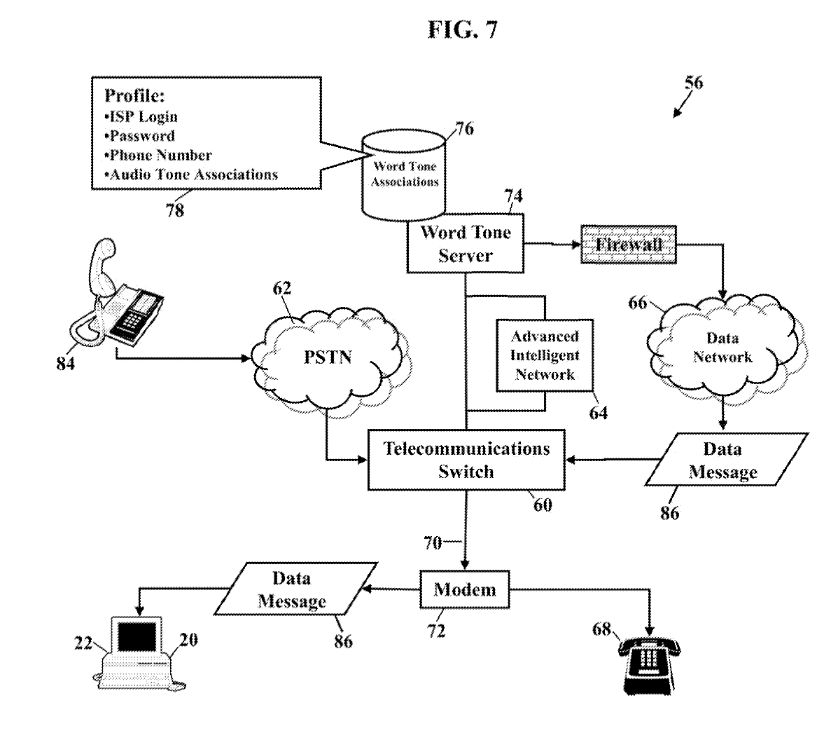

FIG. 7 is a schematic illustrating the processing of an incoming communications signal. A calling party uses a communications device at an originating telephone number to place a call to the called telephone 68. FIG. 7 shows the communications device as a second telephone 84. The call is routed from the second telephone and into the PSTN 62. If, on the other hand, the communications device is a wireless device, the call is transmitted to an antenna (not shown), then coupled to a mobile switch (also not shown), and then routed into the PSTN. The PSTN routes the call to the local central office telecommunications switch 60 serving the called telephone. The intelligence controlling the telecommunications switch (such as the Advanced Intelligence Network 64) detects that customized audio tone service is required (the MN environment, for example, would detect a trigger for customized tone service). The call is suspended and a query is sent to the Word Tone server 74 for the appropriate tone after the incoming communications signal is decoded to associate a Word Tone (scripture set to beat or rhythm), such as a name associated with the originating telephone number. The Word Tone server accesses the customer's profile 78, reads the customer's tones associations 82, and populates the fields and/or files for the incoming communications signal.

Once the appropriate tone is selected, the tone server 74 then requests the appropriate announcement profile format and associates the information for the audio caller identification announcement. If the customer has a static Internet Protocol (IP) address for the computer system 22, this static IP address will usually be known from the customer's profile 78. The Word Tone server, therefore, sends the data message 86 to the computer system. The data message includes information associated with the selected tone. The data message is addressed to the IP address of the computer system or to another IP communications device (not shown). The data message is routed over the data network 66, through the telecommunications switch 60, and to the computer system via the connection 70 and the modem 72. The data message includes information associated with the decoded ICLID signal of the incoming communications signal. The Word Tone Notification Module 20 receives the data message 86 and retrieves the selected audio tone fields and/or files from the memory of the computer system. The selected audio tone fields and/or file are then audibly played by the computer system. Once the selected tone is played at the computer system, the telecommunications switch then resumes processing the call. The incoming communications signal is routed to the called telephone 68 via the connection and the modem.

The customer may also specify when the audio tone is presented. The customer may have the Word Tone Notification Module 20 present the tone prior to receipt of the incoming communications signal (i.e., incoming call) at the called telephone 68. If the tone is presented prior to the incoming call, the tone would give the customer advance notice of the a Word Tone (scripture set to beat or rhythm). The customer could, alternatively, have the Word Tone Notification Module present and play the tone at the computer system 22 along with presenting the incoming call to the called telephone.

The computer system 22 plays the selected tone. The selected audio tone fields and/or file may reside in the computer system, and the data message 86 tells the Word Tone Notification Module 20 which announcement to play. Alternatively, the selected audio tone fields and/or files may reside in a database server (not shown) of the telecommunications system. The data message may include any protocol that is appropriately understood by the Word Tone server 74, the data network 66, the computer system, and the Word Tone Notification Module. Once the data message is received, the Word Tone Notification Module and the computer system present and play the audio tone (based on the audio tone profile) so that a nearby customer or user is audibly alerted of the a Word Tone (scripture set to beat or rhythm). The Word Tone Notification Module and the computer system, for example, could cause the tone to be audibly presented over a pair of speakers.

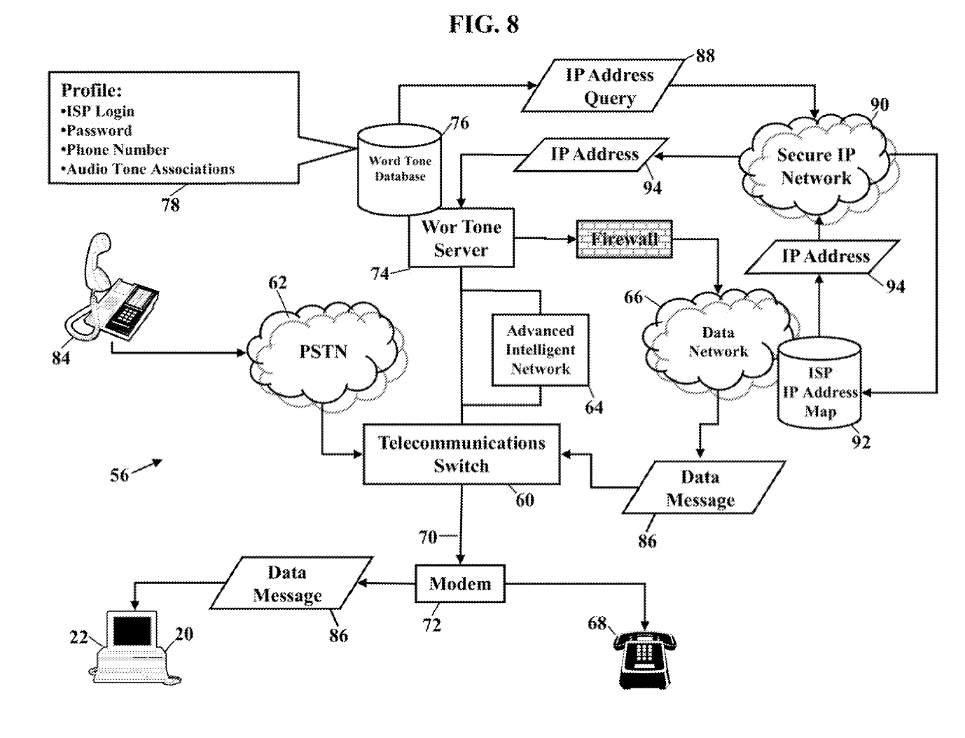

FIG. 8 is a schematic illustrating the processing of the incoming call to the called telephone number in another embodiment of this invention. FIG. 8 differs from FIG. 7, however, in that FIG. 8 illustrates a call flow for dynamic IP addressing. Some Internet Service Providers assign a “static” IP address to a customer's account, whereas other Internet Service Providers dynamically change a customer's IP address. A static IP address is permanently assigned to the customer, while a dynamic IP address may change with each login or may dynamically change during a session. FIG. 8 illustrates additional queries that are made for dynamic IP addressing.

FIG. 8 similarly routes the call as shown in FIG. 7. The call routes from the second telephone 84, into the PSTN 62, and to the local central office telecommunications switch 60 serving the called telephone number. The intelligence controlling the telecommunications switch detects a request for customized announcement service and the call is suspended. A query is sent to the Word Tone server 74 for the appropriate audio tone. The server accesses the customer's profile 78, reads the customer's tone associations, and selects which tone is appropriate. Once the appropriate tone is selected, the Word Tone server then prepares to send the data message 86 to the computer system 22. The data message includes the fields and/or files associated with the audio tone profile of the originating telephone number.

Before the data message 86 can be sent, however, the dynamic IP address of the computer system 22 must be determined. An IP address query 88 is sent from the Word Tone server 74, routed over a secure IP network 90, and to an ISP serving the computer system. The IP address query requests the current IP address assigned to the computer system. FIG. 8 shows the current IP address being retrieved from a database 92 that maps telephone numbers to IP addresses. The current IP address, for example, could be mapped to the ISP login information. If the ISP login information contained within the profile 78 matches the ISP's login information, then the Word Tone server could have access to the database.

Regardless of how the IP address is accessed, the current IP address 94 is returned. The current IP address routes over the secure IP network 90 and to the Word Tone server 74. With the current IP address known, the Word Tone server may now send the data message 86. The data message, including fields and/or files associated with the selected announcement, is sent to the IP address of the called telephone number and to the computer system 22. The data message routes over the data network 66, through the telecommunications switch 60, and to the computer system via the connection 70. The Word Tone Notification Module 20 receives the data message, retrieves the selected audio tone file (or receives the selected audio tone files, if the files are sent by the telecommunications network), and then the word tone is played by the computer system.

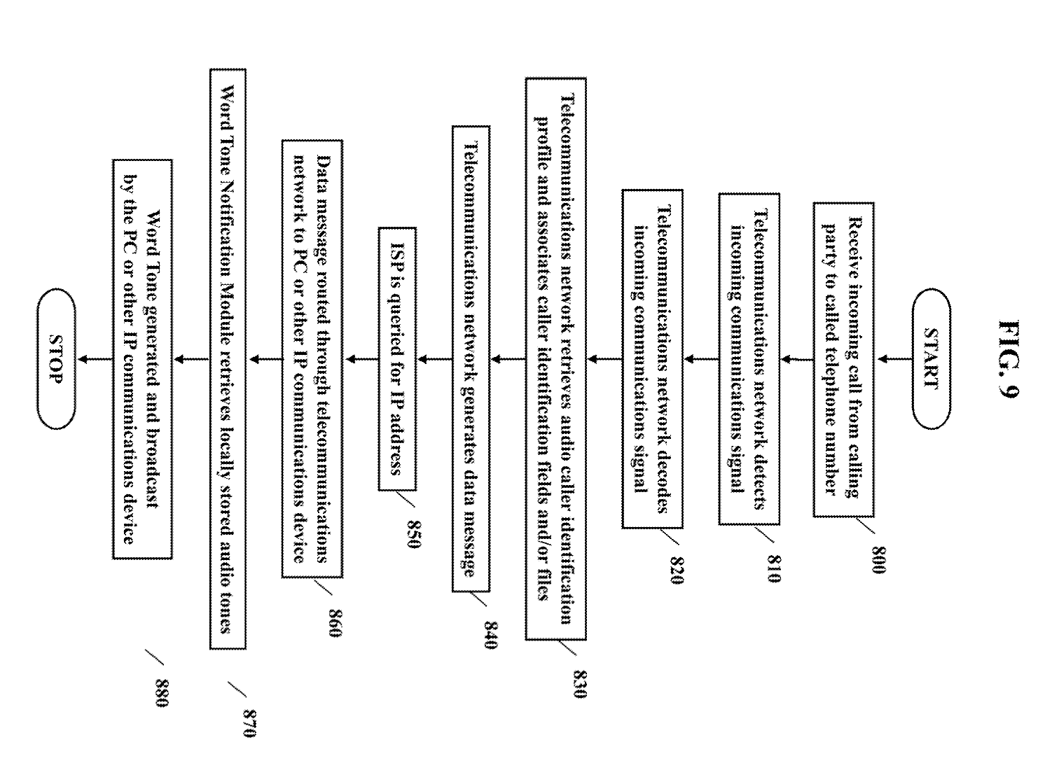

FIG. 9 illustrates a flowchart showing an overview of a process for audio delivery of a Word Tone (scripture set to beat or rhythm) to a PC or other IP communications device according to an embodiment of this invention. The calling party places a call to a called telephone number (block 800). The telecommunications network 68 recognizes the incoming communications signal to a subscribing customer (block 810), decodes the incoming communications signal (e.g., decodes the ICLID and other network data associated with the originating telephone number) (block 820), and obtains the audio a Word Tone (scripture set to beat or rhythm) profile and associated fields and/or files for the incoming communications signal (block 830). Next, this information is processed to generate the data message capable of being sent to the computer system 22 (block 840). Included in this data message is ICLID and other network data, such as calling name, as determined from the Intelligent Network. The ISP is queried, if needed, for an IP address of the called telephone number (block 850). The data message is sent through the telecommunications network (via the switch) to the PC or other IP communications device (block 860), with the data message including information associated a Word Tone (scripture set to beat or rhythm). The PC or other IP communications device retrieves any locally stored associated audio tone association fields and/or files (block 870) and generates an audio tone that is played by the PC or other IP communications device (880). Further, the telecommunications switch connects the incoming call to the called telephone number via a connection to a telephone (block 890).

In an alternate embodiment (not shown), if the audio tone is not enabled (or if an ICLID signal cannot be associated with the originating telephone number), then the telecommunications network may select a default tone. For example, the telecommunications network may announce that the information is “private,” “not available,” “blocked,” or “declined.” As used herein, the term “private” refers to a private or restricted originating telephone number, such as, for example, an unlisted number. As used herein, the term “not available” refers to an originating telephone number that cannot be decoded by the telecommunications network. As used herein, the term “blocked” refers to a telephone number that is blocked by a calling party so that the originating telephone number is not provided. As used herein, the term “declined,” refers to a calling party that opts out of providing the audio tone discussed above.

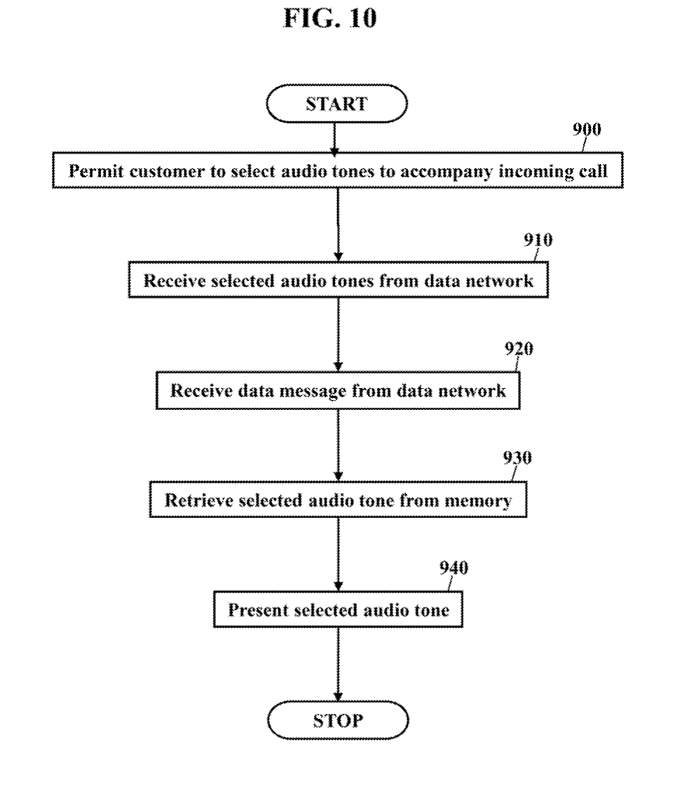

FIG. 10 is a flowchart showing an alternative method of providing audio tones to a called telephone number. This alternative method represents an embodiment of the Word Tone Notification Module (shown as reference numeral 20). A customer is permitted to select audio tone fields and/or files to accompany an incoming call to the called telephone number (block 900). The selected audio tone(s) is downloaded and received from a data network (block 910). When the appropriate audio tone is processed to accompany the incoming communications signal, the Word Tone Notification Module receives a data message from the data network (block 920). The data message tells the Word Tone Notification Module which audio tone is to be presented. The Word Tone Notification Module retrieves the selected audio tone from memory (block 930) and presents the selected audio tone to play with the incoming call (block 940).

While the processes in FIGS. 9 and 10 are shown in series, these processes may occur in different orders and/or at simultaneous times as one of ordinary skill in the art will understand. Further, while the disclosed system and methods indicate that a data message is sent to the PC or IP communications device to associate with locally stored data fields and/or files, the Word Tone may also be generated by the telecommunications network and sent directly to the PC or IP communications device to be played. In another embodiment, the customer may opt to activate a call handling feature after hearing the audio tone. For example, call handling may allow the Customer to accept the call, allow the customer to send the call to voicemail, allow the customer to send the calling party a message that the customer is unavailable to take the call, forward the incoming communication to another telephone number, or reject the call.

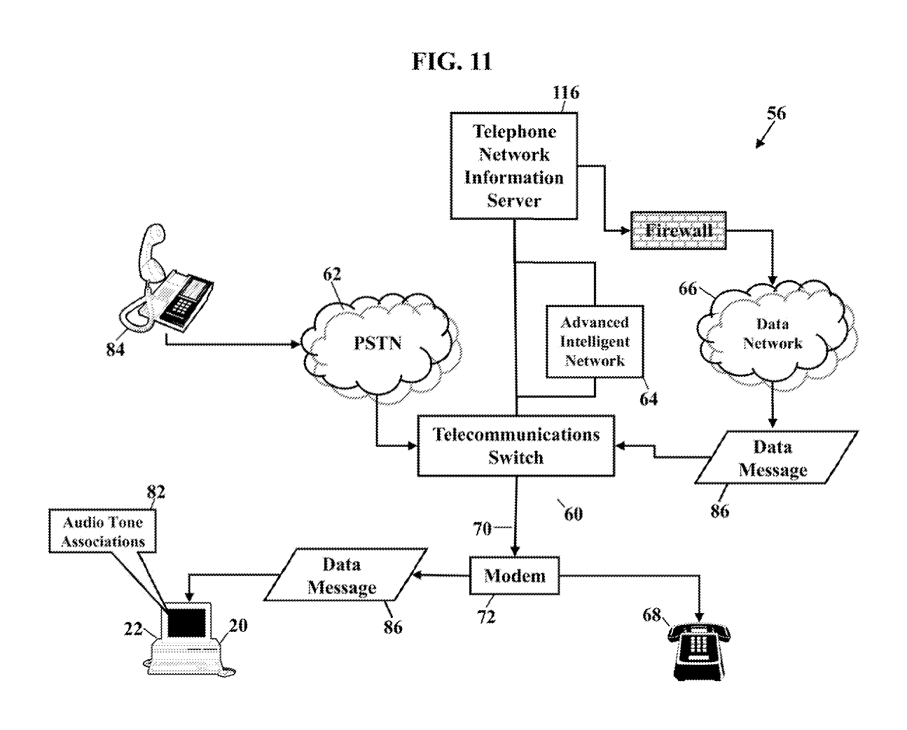

FIG. 11 is a schematic showing another embodiment for the Word Tone Notification Module 20. This alternative embodiment stores the customer's audio tone associations 82 within the memory of the computer system 22. The Word Tone Notification Module 20, again, operates within the memory of the computer system. The incoming communications signal routes from the second telephone 84, into the PSTN 62, and to the local central office telecommunications switch 60 serving the called telephone number. The intelligence controlling the telecommunications switch suspends the processing of the call. A telephone network information server 116 is queried for telephone network information regarding the call. For example, the telephone network information may be associated with the ICLID signal, such as the originating telephone number and other information discussed above. Once the telephone network information is known, the telephone network information server sends the data message 86 to the computer system. The data message includes the telephone network information associated with a Word Tone (scripture set to beat or rhythm) of the incoming call.

The data message 86 is delivered to the IP address assigned to the computer system 22, as previously described. When the Word Tone Notification Module 20 receives the data message, the Word Tone Notification Modules locally accesses the customer's audio tone associations. The audio tone associations 82, in this embodiment, are stored within the memory of the computer system. The Word Tone Notification Module uses the audio tone associations and the telephone network information contained within the data message to construct the audio tone to accompany the incoming call. The Word Tone Notification Module could select the appropriate tone based upon a variety of factors as discussed above, such as, for example, the time of day, the day of the week, and/or the originating telephone number. After the Word Tone Notification Module selects the appropriate tone, the selected tone is retrieved from memory and then audibly played by the computer system. The Word Tone Notification Module of this embodiment, therefore, includes logic to select which tone is appropriate to accompany the incoming call.

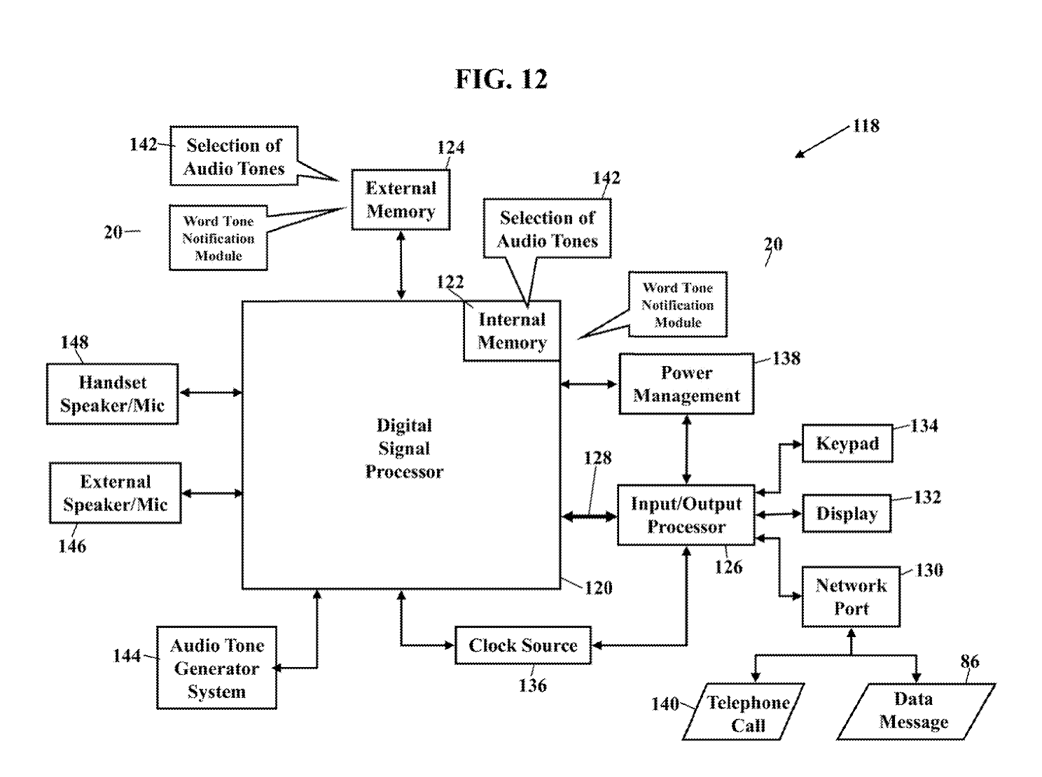

FIG. 12 is a block diagram of an apparatus 118 embodying this invention. This apparatus generates an audio tone for an incoming communications signal to a called telephone number serviced or coupled with a PC or other IP communications device. The apparatus includes the Word Tone Notification Module 20 operating within a memory device of a digital signal processor 120. The memory device could include internal memory 122 of the digital signal processor, or the memory device could include an external memory device 124 communicating with the digital signal processor. The digital signal processor converts analog signals to digital signals and converts digital signals to analog signals. The digital signal processor could include compression and decompression algorithms, cancellation algorithms, audio-processing circuitry, filter circuitry, and amplifier circuitry. Although digital signal processors can be designed to provide differing capabilities and a variety of performance criteria, the basic functions of the digital signal processor are known and, thus, will not be further discussed.

The digital signal processor 120 interfaces with an input/output processor 126. The input/output processor controls system input/output and provides telephony-like control features. A bus 128 provides a signal communication path between the digital signal processor 120 and the input/output processor. The input/output processor is a microprocessor that includes memory (not shown), communication controllers (not shown), and peripheral controllers (not shown). The communication controllers, for example, could control packet-based communications with a data network (shown as reference numeral 66 in FIGS. 2-7 and 10) through a network port 130. The communication controllers could also control packet-based communications with a telecommunications switch (shown as reference numeral 60 in FIGS. 2-7 and 10) through the network port. The peripheral controllers provide an interface with an LCD/LED/CRT display 132 and with telephony-like control features, such as a keypad 134. A clock source 136 provides a system clock for the apparatus 118, and the clock source may also include higher and lower frequency multiples of the system clock depending upon power requirements and power availability. A power management system 138 provides differing power control mechanisms, such as a sleep mode and a low-power mode, to efficiently utilize available power and to reduce thermal management concerns.

The apparatus 118 plays a Word Tone audio tone for incoming calls 140. If for example, the apparatus communicates with the telecommunications switch (shown as reference numeral 60 in FIGS. 2-7 and 10), the Word Tone Notification Module 20 causes the apparatus to play the audio tone to alert a nearby customer or user of an incoming call. The network port 130 receives the data message 86 via the communications link (shown as reference numeral 70 in FIGS. 2-7 and 10) to the telecommunications switch. The data message is received from the data network (shown as reference numeral 66 in FIGS. 2-7 and 10). The data message may include information associated with an audio tone selected by the telecommunications system (shown as reference numeral 56 in FIGS. 2-7 and 10) to accompany the incoming call. The data message could also include telephone network information (such as that information provided by the telephone network information server 116 of FIG. 10) provided by the telecommunications system. When the data message is received, the digital signal processor 120 interfaces with the Word Tone Notification Module and with the internal memory device 122 and/or the external memory device 124. The Word Tone Notification Module instructs the digital signal processor to retrieve the selected audio tone from a selection of tones 142 stored in the memory device. The audio tone is selected based upon the information contained within the data message as previously discussed.

Once the announcement is selected, the apparatus 118 generates the Word Tone audio tone. The digital signal processor 120 interfaces with an announcement generator system 144. The Word Tone generator system executes the selected audio tone fields and/or files and generates the audio tone. The digital signal processor and the Word Tone generator system could also interface with an external speaker/microphone (mic) system 146 to audibly broadcast the selected audio tone.

The Word Tone Notification Module (shown as reference numeral 20 in FIG. 1) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-customers, licensees, and assignees. These types of computer-readable media, and other types not mention here but considered within the scope of this invention, allow the Word Tone Notification Module to be easily disseminated. A computer program product for providing custom audio tones for telephones comprises the computer-readable medium and the Word Tone Notification Module. The Word Tone Notification Module is stored on the computer-readable medium.

While several implementation of various embodiments of this invention are described herein, various modifications and alternate embodiment will occur to those skilled in the art. For example, one of ordinary skill in the art would recognize that ring backs or audio recordings could be played to an incoming caller from a communications switch or other network device. Accordingly, this invention is intended to include those other variations, modifications, and alternate embodiments that adhere to the spirit and scope of this invention.

What is claimed:

1. A method that includes all patentable subject matter set forth in the application and drawings.

2. A system that includes all patentable subject matter set forth in the application and drawings.
